(19) United States
(12) Patent Application Publication
(10) Pub. No.: US 2011/0243256 A1
(43) Pub. Date: Oct. 6, 2011

(54) ELECTRONIC APPARATUS AND STARTUP CONTROL METHOD

(75) Inventor: Yoshio MATSUOKA, Tokyo (JP)

(73) Assignee: KABUSHIKI KAISHA TOSHIBA, Tokyo (JP)

(21) Appl. No.: 12/986,650

(22) Filed: Jan. 7, 2011

(30) Foreign Application Priority Data
Mar. 30, 2010 (JP) P2010-079820

(51) Int. Cl. H04L 27/00

(52) U.S. Cl. 375/259

(57) ABSTRACT

In one embodiment, there is provided an electronic apparatus into which a removable storage medium having a wireless communication function is inserted. The apparatus includes: a generator that generates a first key for encoding data, and a second key for decoding the data encoded by the first key; a storage medium controller that writes first data into the storage medium when starting up the electronic apparatus, and monitor whether or not the first data are rewritten to second data; a decoder that decodes the second data using the second key when the storage medium controller determines that the first data are written to the second data; and a startup controller that determines whether or not the decoded second data are identical to the first data, and stop starting up the electronic apparatus when determining that the decoded second data are not identical to the first data.

### CROSS-REFERENCE TO RELATED APPLICATION

This application claims priority from Japanese Patent Application No. 2010-079820, filed on Mar. 30, 2010, the entire contents of which are hereby incorporated by reference.

### BACKGROUND

1. Field

Embodiments described herein generally relate to an electronic apparatus and a startup control method.

2. Description of the Related Art

Recently, with the wide use of client PCs, the importance of information security has been increasing.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a schematic diagram of an authentication system according to an embodiment of the present invention;

FIG. 2 is a functional block diagram of a client PC according to the present embodiment;

FIG. 3 is a block diagram of the authentication system according to the present embodiment;

FIG. 4 is a sequence diagram of authentication processing according to the present embodiment;

FIG. 5 is a flow chart illustrating a procedure of processing for registration of a wireless memory card according to the present embodiment;

FIG. 6 is a flow chart illustrating a procedure of processing for startup of the wireless memory card according to the present embodiment;

FIG. 7 is a flow chart illustrating a procedure of processing for startup of the client PC according to the present embodiment; and

FIG. 8 is a flow chart illustrating a procedure of authentication processing executed by a server according to the present embodiment.

### DETAILED DESCRIPTION

According to exemplary embodiments of the present invention, there is provided an electronic apparatus into which a removable storage medium having a wireless communication function is inserted. The apparatus includes: a generator configured to generate a first key for encoding data, and a second key for decoding the data encoded by the first key; a communication module configured to perform wireless communicate with a server using the wireless communication function of the storage medium; a transmission module configured to transmit the first key to the server via the communication module; a storage medium controller configured to write first data into the storage medium when starting up the electronic apparatus, and monitor whether or not the first data are rewritten to second data; a decoder configured to decode the second data using the second key when the storage medium controller determines that the first data are written to the second data; and a startup controller configured to determine whether or not the decoded second data are identical to the first data, and stop starting up the electronic apparatus when determining that the decoded second data are not identical to the first data.

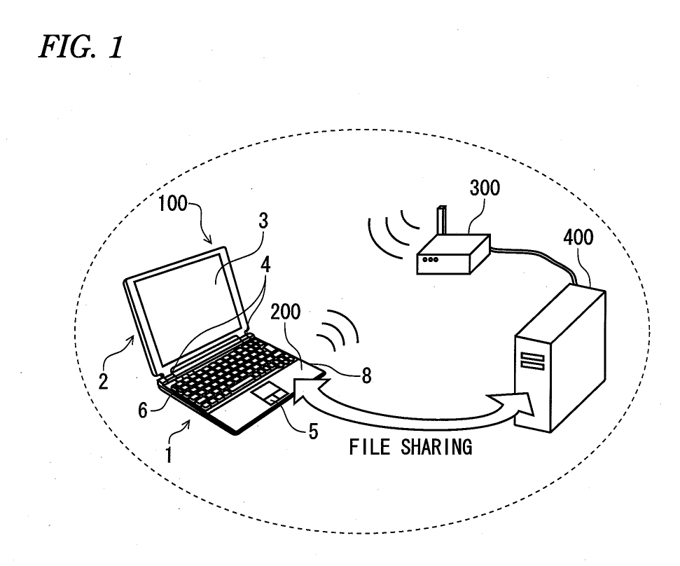

Hereinafter, an embodiment of the present invention will be described with reference to FIGS. 1 to 8.

First, an authentication system according to the present embodiment will be now described. FIG. 1 is a schematic diagram of the authentication system according to the present embodiment.

The authentication system according to the present embodiment includes: a client PC 100; a wireless memory card 200 inserted into the client PC 100; a wireless router 300; and a server 400.

The client PC 100 performs wireless communication via the wireless memory card 200.

The wireless memory card 200 has: a memory function for storing data; and a wireless communication function for performing wireless communication. The wireless memory card 200 has a wireless communication control circuit by itself, and is capable of releasing data, stored in a memory, externally via a wireless LAN DHCP (Dynamic Host Configuration Protocol) connection.

The wireless router 300 wirelessly communicates with a communication apparatus that is present within a certain range.

The server 400 communicates, via the LAN-connected wireless router 300, with the communication apparatus that is present within the certain range. Further, the server 400 establishes a connection with the wireless memory card 200 using an FTP (File Transfer Protocol) serving as an example of a file transfer protocol, thereby sharing a file between the server 400 and the wireless memory card 200.

The client PC 100 will be described as an electronic apparatus according to the present invention by way of example. Firstly, a structure of the client PC 100 will be described with reference to FIG. 1.

The client PC 100 is provided with a main body 1 and a display unit 2. The display unit 2 is rotatable about the main body 1 via hinges 4. The main body 1 includes: a touch pad 5; a keyboard 6; a power switch 7; and a card slot 8. The display unit 2 is provided at its center with a display device 3.

The display device 3 displays video based on a video signal sent from a graphic chip mounted on a board. The display device 3 is an LCD (Liquid Crystal Display) or the like, for example.

A main body casing 2a has, at its upper face, operation devices such as the touch pad 5 and the keyboard 6, and a board, a HDD (Hard Disk Drive) 16, etc is housed in the main body casing 2a. Furthermore, the main body casing 2a is, on its side, provided with the card slot 8 into which the removable wireless memory card 200 or the like is inserted.

The keyboard 6 is an input device provided at the upper face of the main body casing 2a. In accordance with an operation performed on a button of the keyboard 6, an operational signal for an operation such as character input or icon selection is transmitted to each associated module.

The touch pad 5 is a pointing device provided at the upper face of the main body casing 2a. In accordance with an operation performed on the touch pad 5, an operational signal for an operation such as screen transition or icon selection is transmitted to each associated part.

The power switch 7 generates a control signal for turning ON/OFF the power of the client PC 100 in response to a user operation.

The card slot 8 is provided at a side face of the main body 1, and removable various cards are inserted into the card slot 8.

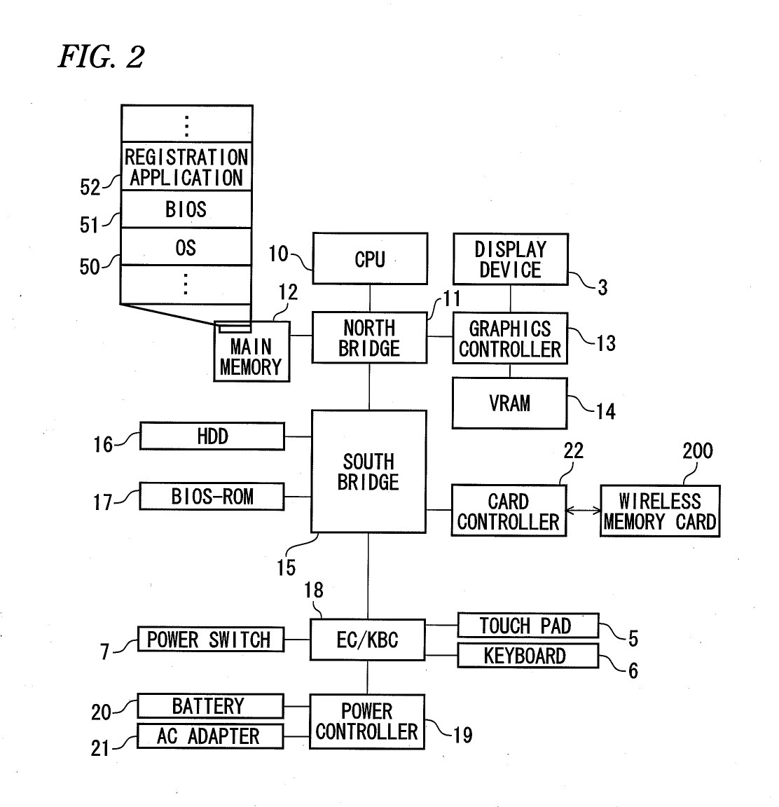

Next, functions of the client PC 100 will be described with reference to FIG. 2. FIG. 2 is a functional block diagram of the client PC 100 according to the present embodiment.

The client PC 100 includes: the touch pad 5; the keyboard 6; the power switch 7; a CPU 10; a north bridge 11; a main memory 12; a graphics controller 13; a VRAM 14; a south bridge 15; the HDD 16; a BIOS-ROM 17; an EC/KBC 18; a power controller 19; a battery 20; an AC adapter 21; and a card controller 22.

The CPU 10 is a processor provided to control operations of the client PC 100, and executes an operating system and various application programs loaded from the HDD 16 into the main memory 12. Further, the CPU 10 loads a system BIOS 51, which is stored in the BIOS-ROM 17, into the main memory 12, and then executes the system BIOS 51. The system BIOS 51 is a program for hardware control.

The north bridge 11 is a bridge device for establishing a connection between a local bus of the CPU 10 and the south bridge 15. The north bridge 11 also internally includes a memory controller for performing access control for the main memory 12. Further, the north bridge 11 also has the function of communicating with the graphics controller 13 via an AGP (Accelerated Graphics Port) bus or the like.

The main memory 12 is a so-called working memory for decompressing the operating system (OS 50) and various application programs stored in the HDD 16, and/or the system BIOS 51 stored in the BIOS-ROM 17.

The graphics controller 13 is a display controller for controlling the display device 3 used as a display monitor of the present computer. From display data drawn in the VRAM 14 by the operating system and/or application programs, this graphics controller 13 generates a video signal for forming a display image to be displayed on the display device 3.

The south bridge 15 makes access to the BIOS-ROM 17, and/or controls disk drives (I/O devices) such as the HDD 16 and an ODD (Optical Disk Drive).

The HDD 16 is a storage device for storing the operating system, various application programs, etc.

The BIOS-ROM 17 is a rewritable nonvolatile memory for storing the system BIOS 51 serving as a program for hardware control.

The EC/KBC 18 controls the touch pad 5 and the keyboard 6 which function as input means. The EC/KBC 18 is a one-chip microcomputer for monitoring and controlling various devices (such as a peripheral device, a sensor and a power circuit) irrespective of the system status of the client PC 100. Moreover, the EC/KBC 18 has the function of turning ON/OFF the power of the client PC 100 in cooperation with the power controller 19 in accordance with an operation of the power switch 7 by the user.

When external power is supplied via the AC adapter 21, the power controller 19 generates, using the external power supplied via the AC adapter 21, system power to be supplied to respective components of the client PC 100. On the other hand, when no external power is supplied via the AC adapter 21, the power controller 19 generates, using the battery 20, system power to be supplied to the respective components (e.g., the main body 1 and the display unit 2) of the client PC 100.

The card controller 22 makes access to a memory of a storage medium inserted into the card slot 8 to read/write data from/into the memory.

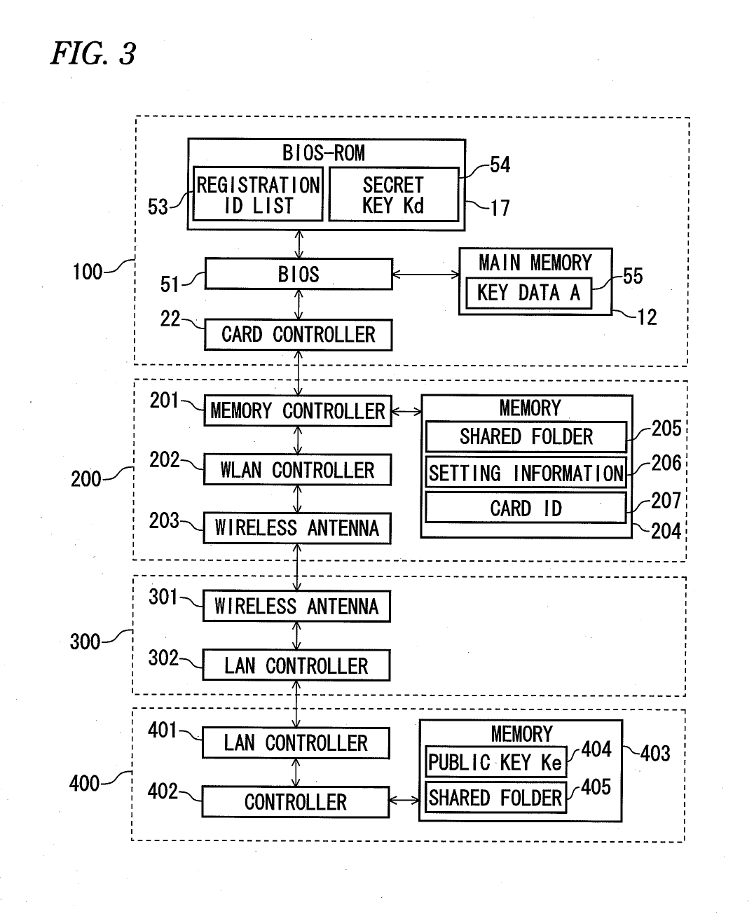

Next, functional components related to the authentication system according to the present embodiment will be now described. FIG. 3 is a block diagram of the authentication system according to the present embodiment.

First of all, the functional components of the client PC 100 will be now described. Since the overall functional components of the client PC 100 have been described above, only the functional components thereof related to the authentication system will be described. Upon turning ON of the system power of the client PC 100, the BIOS 51 starts up to initialize each piece of hardware of the client PC 100. Further, the BIOS 51 makes access to the card controller 22, and thus can be connected to the wireless memory card 200.

The BIOS 51 generates a public key Ke (404) and a secret key Kd (54) when the wireless memory card 200 is registered in the server 400. At the startup of the client PC 100, the BIOS 51 writes key data into a shared folder 205. This key data is, for example, 256-bit data for a random one-time password. The BIOS 51 transmits, to the server 400, the public key Ke 404 for encoding this key data, and stores, in the BIOS-ROM 17, the secret key Kd 54 for decoding the key data encoded by the public key Ke 404.

Furthermore, the BIOS 51 stores an ID of the registered wireless memory card 200 to provide a registration list 53. Moreover, although the BIOS 51 writes key data A into the shared folder 205 at the startup of the client PC 100, the BIOS 51 also stores this key data A in the main memory 12.

Next, the functional components of the wireless memory card 200 will be described. The wireless memory card 200 includes: a memory controller 201; a WLAN controller 202; a wireless antenna 203; and a memory 204. The memory controller 201 connects with the card controller 22, and thus serves as an interface when the BIOS 51 makes access to the memory 204. The WLAN controller 202 controls wireless communication performed via the wireless antenna 203. The memory 204 stores: the shared folder 205 set when an FTP connection is established between the server 400 and the wireless memory card 200; setting information 206 such as a shared folder name for the FTP connection and/or a key data file name; and a card ID 207 unique to the wireless memory card 200.

The wireless router 300 has a wireless antenna 301 and a LAN controller 302. The wireless router 300 wirelessly communicates with the other apparatus located within a range, in which the wireless router 300 can communicate therewith via the wireless antenna 301, and transmits communication details to the server 400 through the LAN controller 302.

The server 400 has a LAN controller 401, a controller 402 and a memory 403. The server 400 is LAN-connected to the wireless router 300 via the LAN controller 401. The memory 403 stores: the public key Ke 404 received when the wireless memory card 200 is registered and set; and a shared folder 405 set upon FTP connection.

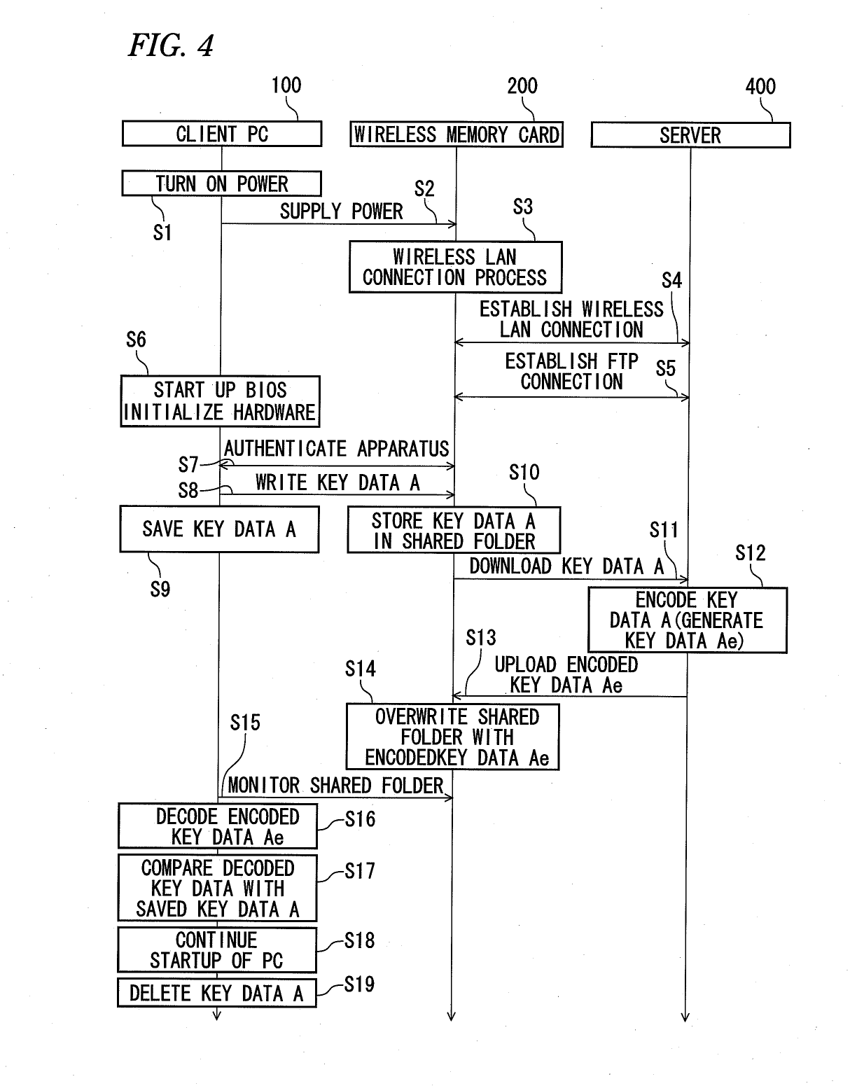

Next, a procedure of authentication processing according to the present embodiment will be described with reference to FIG. 4. FIG. 4 is a sequence diagram of the authentication processing according to the present embodiment.

First of all, the system power of the client PC 100 is turned ON (Step S1). Then, power is supplied to the wireless memory card 200 inserted into the card slot 8 (Step S2). The WLAN controller 202 of the wireless memory card 200 performs a wireless LAN connection process (Step S3). Then, a wireless LAN connection is established between the wireless memory card 200 and the server 400 (Step S4). Subsequently, the WLAN controller 202 establishes an FTP connection with the server 400 to set the shared folder (Step S5).

In parallel with the startup of the wireless memory card 200 performed in Steps S2 to S5, a process for starting up the client PC 100 is performed. In the client PC 100, the BIOS 51 performs hardware initialization (Step S6). Subsequently, the BIOS 51 executes apparatus authentication using the ID of the wireless memory card 200 (Step S7). Upon successful end of the authentication process, the BIOS 51 writes the key data A into the shared folder 205 in the memory 204 via the card controller 22 and the memory controller 201 (Step S8). Further, the BIOS 51 saves, in the main memory 12, key data A 55 identical to the written key data A (Step S9). Furthermore, the memory controller 201 also stores the key data A in the shared folder 205 (Step S10).

The controller 402 of the server 400 monitors the shared folder 405 that is connected to the wireless memory card 200 using FTP, and downloads the key data A in the shared folder 405 upon writing of the key data A into the shared folder 405 (Step S11). The controller 402 encodes the downloaded key data A by the public key Ke 404 to generate encoded key data Ae (Step S12). Subsequently, the controller 402 uploads the encoded key data Ae to the shared folder 405 (Step S13). The memory controller 201 overwrites the shared folder 205 with the uploaded encoded key data Ae (Step S14). The BIOS 51 monitors this shared folder 205 (Step S15). When a rewrite of the shared folder 205 is determined, the encoded key data Ae is decoded by the secret key Kd (54) (Step S16). Subsequently, the BIOS 51 makes a comparison between the saved key data A and the decoded key data (Step S17). Only the secret key Kd 54 can decode the encoded key data Ae into the key data A. Accordingly, when the saved key data A and the decoded key data coincide with each other, a connection is made between the server 400 and the client PC 100, in which the set memory card 200 is registered. Thus, wireless communication is established therebetween, and therefore, the BIOS 51 continues the startup of the client PC 100 (Step S18). Subsequently, the BIOS 51 deletes the key data A 55 from the main memory 12 (Step S19). Thus, the authentication processing according to the present embodiment ends.

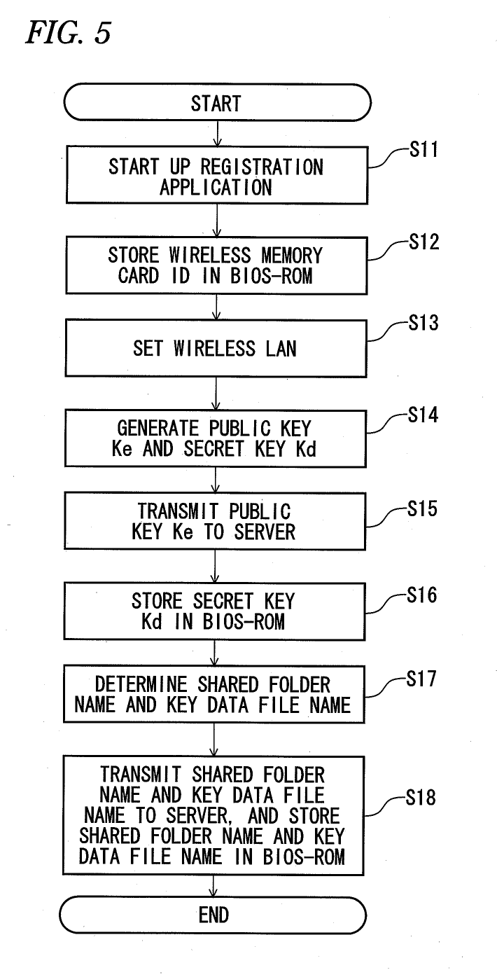

Next, processing procedures executed by the respective devices included in the authentication system according to the present embodiment will be now described with reference to FIGS. 5 to 8. First, the flow of registration of the wireless memory card 200 in the server 400 will be now described. FIG. 5 is a flow chart illustrating a procedure of processing for registration of the wireless memory card 200 according to the present embodiment.

First, the CPU 10 starts up a registration application 52 stored in the HDD 16 (Step S11). Subsequently, the BIOS 51 reads the ID of the wireless memory card 200, and stores the read ID in the BIOS-ROM 17 to provide the registration ID list 53 (Step S12). Next, the WLAN controller 202 sets a wireless LAN with the server 400, and stores the setting information 206 in the memory 204 (Step S13).

Then, the WLAN controller 202 generates the public key Ke (404) and the secret key Kd (54) (Step S14). The registration application 52 transmits this public key Ke (404) to the server 400 (Step S15).

The BIOS 51 stores the secret key Kd 54 in the BIOS-ROM 17 (Step S16). The WLAN controller 202 decides a shared folder name and a key data file name (Step S17). The BIOS 51 transmits the shared folder name and key data file name to the server 400, and stores the shared folder name and key data file name in the BIOS-ROM 17 (Step S18). Thus, the procedure of registration of the wireless memory card 200 ends.

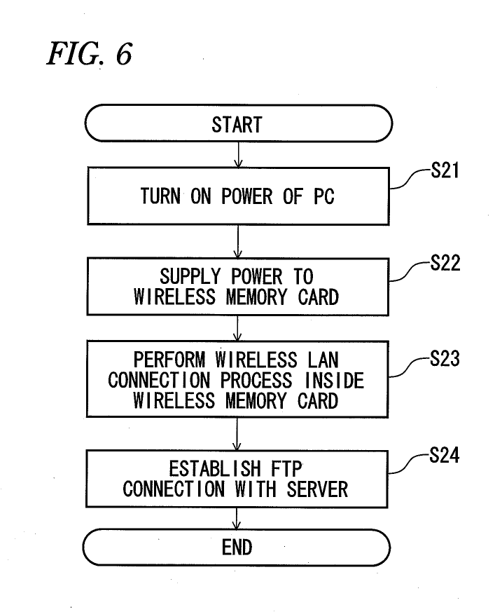

Next, the startup of the wireless memory card 200 inserted into the client PC 100 at the startup of the client PC 100, and the startup of a main body of the client PC 100 will be now described. Firstly, the startup of the wireless memory card 200 will be described with reference to FIG. 6. FIG. 6 is a flow chart illustrating a procedure of processing for the startup of the wireless memory card 200 according to the present embodiment.

Firstly, the system power of the client PC 100 is turned ON (Step S21). Then, power is supplied to the wireless memory card 200 (Step S22). Subsequently, the WLAN controller 202 performs a wireless LAN connection process (Step S23). Then, the WLAN controller 202 establishes an FTP connection with the server 400 (Step S24). In other words, file transfer is carried out between the wireless memory card 200 and the server 400 via the shared folder set at the time of registration of the wireless memory card 200. Thus, the procedure of the startup of the wireless memory card 200 ends.

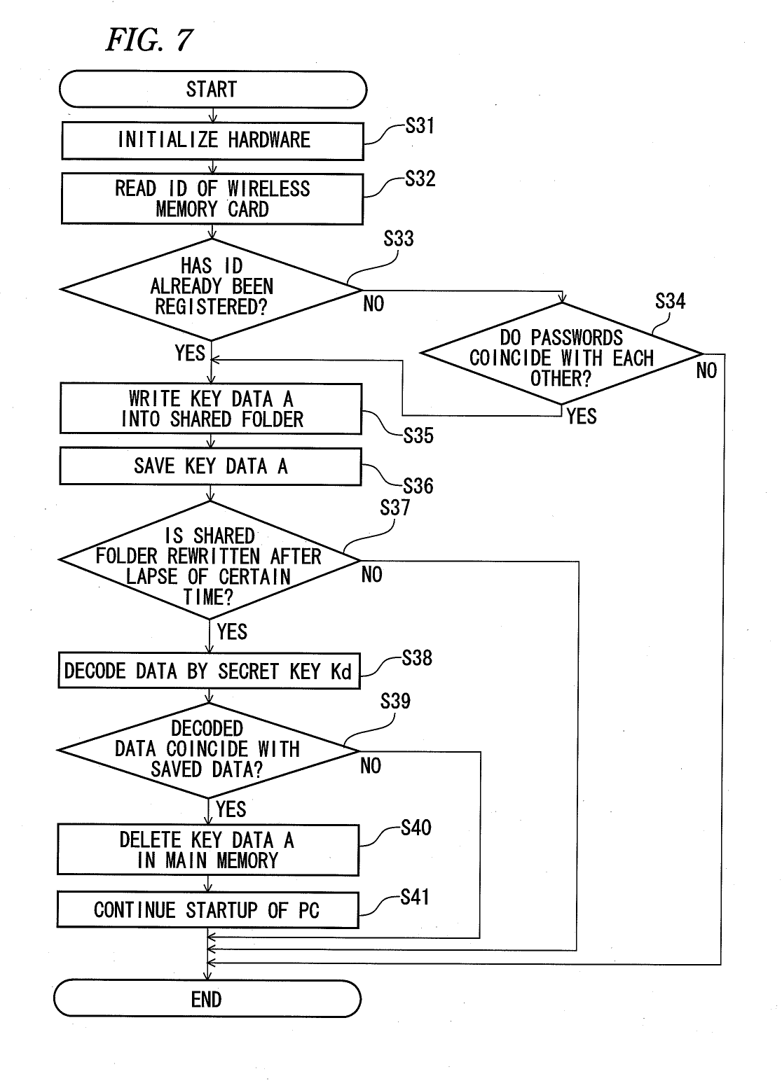

Next, startup processing for the main body of the client PC 100 will be now described. FIG. 7 is a flow chart illustrating a procedure of processing for the startup of the client PC 100 according to the present embodiment.

Firstly, upon turning ON the system power of the client PC 100, the BIOS 51 executes a hardware initialization operation (Step S31). Then, the BIOS 51 reads the ID of the wireless memory card 200 (Step S32). Subsequently, the BIOS 51 determines, with reference to the registration ID list 53, whether or not the read ID has already been registered (Step S33). When the read ID is not registered yet (i.e., No in Step S33), the BIOS 51 displays a password input screen, and determines whether or not an inputted password is identical to a password set in advance for authentication (Step S34).

When the passwords do not coincide with each other, the procedure of the startup of the client PC 100 ends based on the assumption that an unauthorized connection is made. On the other hand, when passwords coincide with each other (i.e., Yes in Step S34), the BIOS 51 then writes the key data A into the shared folder (Step S35). Next, the BIOS 51 saves data, which is identical to the key data A, as the key data A 55 in the main memory 12 (Step S36).

Then, after a lapse of a certain time, the BIOS 51 determines whether or not the shared folder is rewritten with the key data A (Step S37). When the shared folder is not rewritten (i.e., No in Step S37), the startup procedure ends based on the assumption that a wireless LAN connection is not established yet between the wireless memory card 200 and the server 400 or the server 400 is not operated. On the other hand, when the shared folder is rewritten (i.e., Yes in Step S37), the BIOS 51 decodes the rewritten key data by the secret key Kd 54 (Step S38).

Subsequently, the BIOS 51 determines whether or not the decoded key data coincides with the key data A 55 saved in the main memory 12 (Step S39). When the decoded key data does not coincide with the data saved in the main memory 12 (i.e., No in Step S39), the BIOS 51 ends the startup procedure. More specifically, when the encoded key data Ae cannot be decoded into the original key data A, the client PC 100 to which the wireless memory card 200 is currently connected is different from the client PC 100 to which the wireless memory card 200 has been connected at the time of registration thereof; hence, the startup of the client PC 100 is assumed to be that of the client PC 100 performed by an unauthorized user, and the startup of the client PC 100 is therefore stopped.

Then, when the decoded key data coincides with the data saved in the main memory 12 (i.e., Yes in Step S39), the BIOS 51 deletes the key data A 55 saved in the main memory 12 (Step S40). The BIOS 51 continues the startup of the client PC 100 (Step S41). Thus, the procedure of the startup processing for the client PC 100 ends.

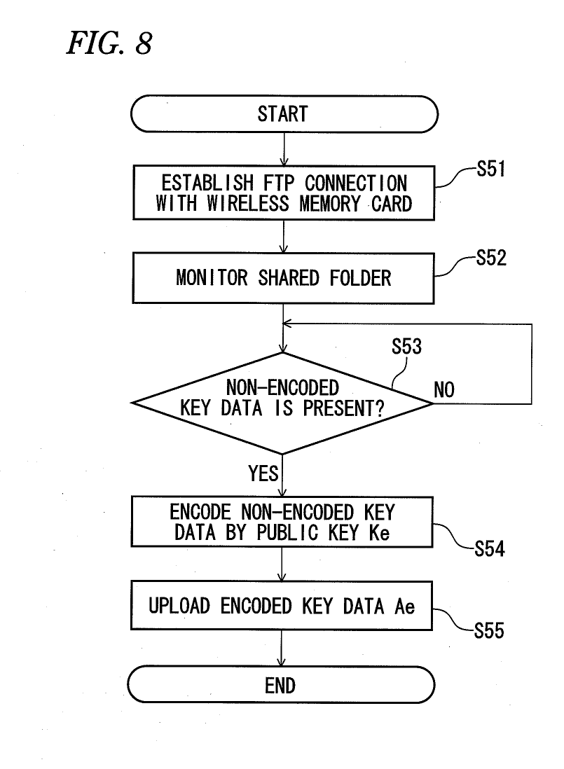

Next, authentication processing executed by the server 400 will be now described. FIG. 8 is a flow chart illustrating a procedure of the authentication processing executed by the server 400 according to the present embodiment.

First, the LAN controller 401 establishes an FTP connection with the wireless memory card 200 (Step S51). Subsequently, the controller 402 monitors the shared folder via the FTP connection (Step S52). The controller 402 determines whether or not non-encoded key data are present in the shared folder (Step S53). When non-encoded key data are not present (i.e., No in Step S53), the processing returns to Step S53. On the other hand, when non-encoded key data are present (i.e., Yes in Step S53), the controller 402 encodes the non-encoded key data using the public key Ke (404) stored in the memory 403 (Step S54). Then, the controller 402 uploads the encoded key data Ae to the shared folder (Step S55). Thus, the procedure of the authentication processing executed by the server 400 ends.

According to the present embodiment implemented as described above, the startup of the client PC 100 can be controlled via the wireless function of the wireless memory card 200 having the wireless communication function by itself. Specifically, when the wireless memory card 200 is registered in the server 400, the public key Ke (404) for encoding key data is held in the server 400, and the secret key Kd (54) for decoding the key data encoded by the public key Ke (404) is held in the client PC 100, thereby making it possible to perform the authentication processing for the client PC 100. Further, authentication is performed by the BIOS 51, thus making it possible to perform authentication processing in parallel with the startup of hardware of the client PC 100, and to stop the startup thereof more rapidly when the client PC 100 is used in an unauthorized manner. Furthermore, since authentication is performed by utilizing the wireless function of the wireless memory card 200, the load on software of the client PC 100 can also be reduced.

While certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the sprit of the invention. The accompanying claims and their equivalents are intended to cover such forms or modifications as would fall within the scope and sprit of the invention.

What is claimed is:

1. An electronic apparatus comprising:
a removable storage medium having a wireless communication function;
a generator configured to generate a first key for encoding data, and a second key for decoding the data encoded by the first key;
a communication module configured to perform wireless communication with a server using the wireless communication function of the storage medium;
a transmission module configured to transmit the first key to the server via the communication module;
a storage medium controller configured to write first data onto the storage medium when starting up the electronic apparatus, and monitor whether the first data are written to second data;
a decoder configured to decode the second data using the second key based on when the storage medium controller determines that the first data are written to the second data; and
a startup controller configured to determine whether the decoded second data are identical to the first data, and stop starting up the electronic apparatus based on a determination that the decoded second data are not identical to the first data.

2. The apparatus of claim 1, wherein the first data are transferred to the server.

3. The apparatus of claim 1, wherein the second data are encoded by the server using the first key.

4. A startup control method for an electronic apparatus comprising:
inserting a removable storage medium having a wireless communication function into the electronic apparatus;
generating a first key for encoding data, and a second key for decoding the data encoded by the first key;
performing wireless communication with a server using the wireless communication function of the storage medium;
transmitting the first key to the server via the communication module;
writing first data into the storage medium when starting up the electronic apparatus;
monitoring whether the first data are written to second data;
decoding the second data using the second key based on a determination that the first data are written to the second data;
determining whether the decoded second data are identical to the first data; and
stopping starting up the electronic apparatus based on a determination that the decoded second data are not identical to the first data.

5. The method of claim 4, wherein the first data are transferred to the server.

6. The method of claim 4, wherein the second data are data encoded by the server using the first key.
